(19) United States
(12) Patent Application Publication
(10) Pub. No.: US 2003/0170538 A1
(43) Pub. Date: Sep. 11, 2003

(54) Fluorine type adhesive resin composition

(76) Inventors: Yoshiyuki Miyaki, Kyoto (JP); Kazuyoshi Ohashi, Kyoto (JP); Benoit Barriere, Barc (FR); Michael Burchill, Langhorne, PA (US)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/088,342

(22) PCT Filed: Jul. 11, 2001
(86) PCT No.: PCT/EP01/08018

(30) Foreign Application Priority Data
Jul. 18, 2000 (JP) 2000-216895

(51) Int. Cl. C08K 3/00; H01M 4/62

(52) U.S. Cl. 429/217; 524/502

(57) ABSTRACT

To introduce polar group by a simple and easy method without spoiling solvent-resistance and mechanical/thermal properties which fluorine type resin inherently possess to provide a fluorine type resin composition improved in adhesion. To provide an electrode structure for battery improved in adhesion between the electrode active material and the current collector by using the composition as a binder. Solution measure: partially denatured fluorine type resin (B′) obtained by partial dehydrogenfluoride reaction and oxidation reaction is mixed to at least one fluorine type resin (A) at a weight ratio of (A/B′) of 30/70 to 99/1.

### FIELD OF INVENTION

This invention relates to a fluorine type resin composition improved in adhesion to substrates such as metals and an electrode for battery having the composition as binder for electrode.

### PRIOR ARTS

Fluorine type resin such as polytetrafluoroethylene (PTFE) and polyvinylidene fluoride (PVDF) is used in a variety fields such as paints, electric and electronics parts, liner for steel pipes, chemical plant parts, weather- and soil-resisting film owing to its excellent weather-resistance, chemical-resistance, solvent-resistance and soil-resistance.

Fluorine resin, however, have a demerit of no or little adhesion to other materials, so that it is very difficult to prepare a composite material combined with other materials or to denature this resin.

In order to improve its properties such as adhesion, coloring and dispersibility in medium, chemists tried to introduce polar group by copolymerization with polarity monomer or by grafting under radiation.

JP-B1-2-604, for example, proposes to introduce carboxylic acid group in PVDF type resin directly by copolymerizing carboxylic acid group or its similar monomer that can be transformed to the group such as acrylic acid, methacrylate and esters of these monomers with vinylidene fluoride monomer.

This method, however, has such demerits that preparation of the monomer having carboxylic acid group to be copolymerized with PVDF type resin is so sophisticated or complicated, polymerization speed drop sharply when such special monomer is not used due to copolymerization kinetics with the fluorine-containing monomer, or expected high molecular weight can not be obtained, or inherent properties of the resin are spoiled by the introduction of such co-monomer.

JP-A1-50-41791 discloses a grafting technique to graft fluorine monomer having carboxylic acid group under exposure to ionized radiation. This method, however, has such demerits that it is difficult to use in industrial plants due to handling problem of radioactive rays, in addition to such problems as decomposition reaction of main chain of the polymer and cross-linking reaction.

In summary, all known techniques concerning fluorine-containing polymers have some difficulty when they are used in industrial plants.

On the other hand, a lot of lithium secondary batteries are used recently in portable device such as portable telephone, video camera and note type personal computer. In this secondary battery, carbonous material such as coke and graphite that can dope and de-dope lithium ions is used as negative pole active material (JP-A1-62-90863), while its positive electrode active material is made of oxide of transition metal such as manganese oxide and vanadium pentaoxide, sulfide of transition metal such as iron sulfide and titanium sulfide and their composite compounds with lithium such as lithium cobalt compound oxide, lithium cobalt nickel compound oxide, lithium manganese oxide.

These electrodes are produced generally by the steps of mixing fine particles of electrode active materials with suitable amount of binder to prepare a paste, coating the resulting paste onto a surface of a current collector, drying the paste and then compressing the dried paste.

Binder used to produce such electrodes for secondary battery must have enough resistance to organic solvent used in electrolyte and resistance to active species which are produced during reaction on electrodes and must have enough solubility to solvent which is used in its manufacturing stage. PVDF resin satisfies these requirements and hence is used as binder in many cases.

PVDF resin, however, have such problems that an active material peels easily off the current collector because of its inherent property of poor adhesion to metals so that that the cycle characteristic of the resulting battery becomes very poor. In fact, adhesion between the current collector and the active material is not sufficient after the active material is compacted onto the current collector, in both cases of negative pole and positive electrode.

JP-A1-5-6766 proposes to roughen a surface of the current collector to improve adhesion between the current collector and the electrode active materials. However, satisfactory adhesion can not be obtained by this technique and improvement is required.

JP-A1-6-172452 proposes a copolymer of vinylidene fluoride and a monomer having carboxylic acid group. However, copolymerization of fluorine type monomer with other monomer having carboxylic acid group is not easy and hence this solution is not applicable to industrial mass-production plant.

JP-A1-9-82311 and JP-A1-9-82314 propose to add sulfur-containing organic compound having mercapto group into an electrode binder paste.

JP-A1-9-199132, JP-A1-9-199134 and JP-A1-9-199130 propose to add acryl resin having functional group or PVDF copolymer or both of them to PVDF resin to prepare the binder. Addition of acryl resin, however, is not desirable from the viewpoint of electrochemical stability.

### PROBLEMS TO BE SOLVED BY THE INVENTION

An object of this invention is to provide a fluorine type adhesive resin composition in which polar group is introduced by a simple and easy method without spoiling solvent-resistance and mechanical/thermal properties which fluorine type resin inherently possess.

Another object of this invention is to provide an electrode structure for battery improved in adhesion between the electrode active material and the current collector by using the composition as a binder.

### MEANS TO SOLVE THE PROBLEMS

Inventors found such a fact that adhesion with other material such as metal can be improved by incorporating a chemically denatured fluorine type resin (B′) obtained by partial dehydrogenfluoride and oxidation reaction in fluorine type resin (A), without spoiling inherent properties of the fluorine resin.

Inventors also found that adhesion between the electrode active material and the current collector is improved remarkable when the fluorine type adhesive resin composition is used as binder in electrodes for the battery.

This invention completed on the base of such findings.

This invention concerns a fluorine type adhesive resin composition consists of (A) at least one fluorine type resin and (B′) at least one chemically denatured fluorine type resin obtained by partial dehydrogenfluoride reaction and oxidation reaction.

The “fluorine type resin (A)” used in the present invention may be polytetrafluoroethylene, polyvinylfluoride, polytrifluoroethylene, polytrifluorochloroethylene, ethylene/tetrafluoroethylene copolymer, tetrafluoroethylene-hexafluoropropylene copolymer and polyvinylidene fluoride (PVDF). Among them, PVDF is preferably used in the present invention because PVDF can be processed easily in solution mode, dispersion mode and molten modes.

PVDF type resin used in the present invention may be homopolymer or copolymer of vinylidene fluoride. Vinylidene fluoride homopolymer can be obtained by suspension polymerization or emulsion polymerization of vinylidene fluoride monomer and possess preferably a melt flow rate (MFR) at 230° C. under a load of 2.16 kg is 0.005 to 300 g/10 minutes, more preferably 0.01 to 30 g/10 minutes.

The copolymer of vinylidene fluoride is a copolymer of vinylidene fluoride monomer and co-monomer(s) copolymerizable therewith. A proportion of vinylidene fluoride in the copolymer is 10 to 99% by weight and preferably 50 to 99% by weight. The co-monomer may be fluorine monomer such as tetrafluoroethylene, hexafluoropropylene, trifluoroethylene, trifluorochloroethylene, vinylfluoride and perfluoro alkyl vinyl ether and unsaturated olefin type monomer such as ethylene and propylene. One or more than one monomers can be used. These copolymer can be obtain by suspension polymerization or emulsion polymerization of the above-mentioned monomers and possess preferably a melt flow rate (MFR) at 230° C. under a load of 2.16 kg is 0.005 to 300 g/10 minutes, more preferably 0.01 to 30 g/10 minutes.

The chemically denatured fluorine type resin (B′) is obtained by subjecting a fluorine type resin (B) to partial dehydrogenfluoride and to oxidation. The fluorine type resin (B) has following unit:

Chemical formula 1

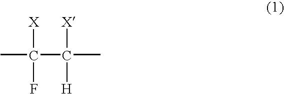

Wherein, X and X′ are same or different and each represents an atom selected from hydrogen, halogen (especially, fluorine or chlorine) or perhaloalkyl (especially, perfluoroalkyl).

Functional group having adhesive property can be introduced into this fluorine type resin owing to the above-mentioned chemical reactions.

The fluorine type resin (B) from which the chemically denatured fluorine type resin (B′) is prepared can be obtained by a polymerization of unsaturated olefin monomer. In practice, the fluorine type polymer represented by the formula (1) can be obtained by polymerizing such monomer as having a fluorine atom bonded to a carbon atom and hydrogen atom bonded to a carbon atom, such as homopolymer of hydro fluorocarbon monomer and copolymer of unsaturated perfluoro monomer and one or more than one monomer containing hydrogen atom.

Unsaturated olefin monomer used to prepare the fluorine type resin (B) may be tetrafluoroethylene, hexafluoropropylene, vinylidenefluoride, trifluorochloroethylene, 2-chloropentafluoropropene, trifluoroethylene, perfluoroalkylvinyl ether, 1-hydropentafluoropropene, 2-hydropentafluoro propene, dichlorodifluoroethylene, 1,1-dichlorofluoroethylene and perfluoro-1,3-dioxsol (U.S. Pat. No. 4,558,142). Other unsaturated olefin monomer having no fluorine atom such as ethylene, propylene and butylene also can be used.

Fluorine type resin (A) and (B) can be: prepared by known technique. For example, homopolymer of vinylidene fluoride can be obtained by suspension polymerization of vinylidene fluoride (U.S. Pat. No. 3,553,185 and EP 0,120,524) or emulsion polymerization (U.S. Pat. Nos. 4,025,709, 4,569,978, 4,360,652, 4,626,396 and EP 0,655,468).

Unsaturated fluorinate olefin monomer is usually polymerized in a form of aqueous emulsion and can be copolymerized with olefin monomer having no fluorine atom. In this case, water-soluble initiator such as ammonium or alkali metal persulfate and alkali metal permanganate or organic peroxide is used as an initiator. As emulsifier, ammonium salt or alkali metal salt of perfluorooctanoic acid or the like is used. Initiator used in case of aqueous colloid suspension may be those soluble in organic phase such as dialkylperoxide, alkylhydroperoxide, dialkylperoxydicarbonate and dialkylazoperoxide. Dispersant may be methyl cellulose, methylhydroxy propyl cellulose, methylpropyl cellulose, methylhydroxyethyl cellulose or the like.

Fluorine resin (A) and (B) are available on market and can be “KYNAR” which is a product of ATOFINA SA.

The fluorine type resin (B) is preferably in a form of aqueous dispersion such as suspension or emulsion before it is denatured to the chemically denatured fluorine type resin (B′). Such dispersion is obtained by the above-mentioned polymerization technique. In fact, such fluorine type resin B is subjected to partial dehydrogenfluoride reaction with base and then is oxidized with oxidizing agent to obtain the chemically denatured fluorine type resin (B′).

The “dehydrogenfluoride” of the fluorine resin is carried out in water or in organic solvent by means of base. The base which can be used in the present invention is those disclosed in WO 98/08880 and may be hydroxide such as potassium hydroxide, sodium hydroxide, lithium hydroxide, ammonia water, carbonate such as potassium carbonate and sodium carbonate, tertiary amines, tetra ammonium hydroxide and metal alkoxides. Amines having a hydrocarbon structure soluble in water or organic solvent partly or totally such as 1,8-diazobicyclo[5.4.0]undeca-7-en (DBU) and 1,4-diazobicyclo-2.2.2-octane (DABCO) also can be used. The dehydrogenfluoride reaction of fluorine resin emulsified in aqueous medium is described in details in WO 98/08879 the contents of which forms a part of this specification.

The above-mentioned base is used together with catalyst. This catalyst may be tetrabutylammoniumbromide (TBAB) and tetraalkyl phosphoric acid, alkylallyl phosphoric acid, alkyl ammonium halide and alkyl phosphate.

After the dehydrogenfluoride reaction, the resulting fluorine resin is subjected to oxidation reaction with oxidizing agent in aqueous medium. Hydrogen peroxide is advantageously used as the oxidizing agent because the reaction can be effected in water which is desirable comparing to organic solvent from the view point of environment and cost and because treatment of wastewater is easier then other oxidizing agents. Other oxidizing agent such as palladium halogenide such as PdCl2, chromium halogenide such as CrCl4, alkyl metal permanganate such as potassium permanganate, alkyl peroxide, a variety of peroxides and persulfuric acid also can be use alone or in combination with hydrogen peroxide.

The oxidation reaction of fluorine resin with hydrogen peroxide is carried out preferably at a pH of 6.5 to 8.0, more preferably between pH 6.7 and pH 7.6. If pH is lower than 6.7, the speed of oxidation reaction becomes too slow. On the other hand, if pH becomes higher than 8, hydrogen peroxide is decomposed so that the reaction can not be controlled. The oxidation reaction is effected at a temperature of 20° C. to 100° C., preferably 50° C. to 90° C.

Amount of hydrogen peroxide used in the oxidation reaction is 1% to 50% by weight, preferably 2% to 12% with respect to the total amount of fluorine resin used.

The resulting denatured fluorine type resin (B′) show remarkably higher adhesive property to organic and inorganic substrates in comparison with fluorine resins which are not chemically denatured.

In the present invention, the chemically denatured fluorine type resin (B′) is mixed with the fluorine type resin (A) which is not denatured. A ratio of (A/B′) is 30/70 to 99/1, preferably 50/50 to 98/2. Desired adhesive property can be given to the fluorine type resin (A) by mixing them at this ratio without spoiling inherent properties of the fluorine type resin (A) such as chemical-resistance, solvent-resistance, electrochemical stability, mechanical properties and weather-resistance.

Mixing method of the fluorine resins (A) and (B′) is no limited specially and can be a method in which the resins are dissolved in solvent, a method in which the resins are disperse in poor solvent and a method in which the resins are melted. Still more, it is possible to use such a method that one resin is dissolved in a solution while another resin is dispersed in a dispersion.

When the fluorine resins (A) and (B′) are homopolymer or copolymer of vinylidene fluoride, any mixing method mentioned above can be used. In case of the solution method, a solvent such as N-methylpyrolidone, N,N′-dimethylholmeamide, tetrahydrofuran, dimethylacetoamide, dimethyl sulfoxide, hexamethylsulfonamide, tetra-methyl urea, acetone, methylethyl ketone is used. In case of melting method, the fluorine resins (A) and (B′) are kneaded at predetermined proportions in a screw kneader by usual manner to obtain the resin composition of the present invention. Melt-kneading can be effected by Banbury mixer, rubber rolling machine, mono axial or two axial extruder generally at 100 to 300° C., preferably at 150 to 260° C. The temperature depends to resin composition.

Substrate to which the resin composition according to the present invention is adhered is made of, for example, of iron, stainless steel, aluminum, copper, nickel, titanium, lead, silver, chromium, alloys, polymers such as polyvinyl chloride, polyamide such as nylon 6 and nylon 66, polycarbonate, polyester such as polyethyleneterephthalate, ABS resin, inorganic materials such as concrete, stone, glass, wood, organic/inorganic composite material, leather, paper, cotton and wool and can have any form.

### EMBODIMENT OF THE INVENTION

As explained above, the present invention provides a technique to improve adhesion between the fluorine type resin and a variety of materials and to obtain composite materials of fluorine resin and a variety of materials easily. The composite materials can have a variety shape such as film, sheet, board, pipe, rod, strand, monofilament and fiber and can be produced by any technique such as calendaring, extrusion lamination, multilayer-injection, fluidized bed coating, dipping, spray coating and melt-press. The technique of this invention can be applicable to fluorine type coating material or paints in which fluorine resin such as vinylidene fluoride is dissolved or dispersed in a solvent, or to coating of electric cables with fluorine resin as well.

The fluorine type adhesive resin composition according to the present invent is advantageously used in an electrode structure having a current collector to a surface of which at least one electrode active material is deposited with binder, to improve adhesion between the electrode active material and the current collector, to prevent active material from peel off the surface of the current collector in manufacturing stage, and to realize a battery improved in the cycle-characteristic.

In particular, the fluorine type adhesive resin composition according to the present invent is useful in non-aqueous type secondary battery, such as a binder for electrode of lithium ion secondary battery.

The current collector of electrode can be metal foil, metal mesh and three-dimensional porous body. Metal used for this current collector is such a metal that hardly forms an alloy with lithium and may be iron, nickel, cobalt, copper, aluminum, titanium, vanadium, chromium and manganese or alloys of these metals.

Negative pole active material as the electrode active material can be any material hat can dope and de-dope lithium ions and may be mention cokes such as petroleum coke and carbon coke, carbon black such as acetylene black, nature or synthesis graphite, glass carbon, activated carbon, carbon fiber and carbonaceous materials such as sintered body obtained from organic polymer sintered in non-oxidation atmosphere. Copper oxide may be added to these materials.

Positive electrode active material as the electrode active material can be transition metal oxide such as manganese oxide and vanadium pentaoxide, iron sulfide, titanium sulfide and composite compound with lithium (such as lithium cobalt compound oxide, lithium cobalt nickel compound oxide, lithium manganese oxide).

The electrode can be produced by following manufacturing process:

At first, a slurry of predetermined amounts of electrode active material and of binder is prepared. The binder consists of (a) vinylidene fluoride type resin mentioned-above, (b) acryl or methacryl polymer having a functional group which has affinity to metal mentioned above, and (c) organic compound having at least one group which is selected from mercapto group, thioether group, carboxylic acid group and carboxylic acid anhydride group. The electrode active material and the binder are kneaded in the presence of solvent to prepare the slurry. The resulting slurry is applied onto an electrode current collector, dried and press-molded. If necessary, after the slurry is applied, the coated layer is heated at 60 to 250° C., preferably 80-200° C. for 1 minute to 10 hours. The electrode-constructing material may contain electro-conductive material and other additives (copper oxide etc), in if necessary.

Solvent used to prepare the slurry to be coated onto the electrode current collector may be organic solvent such as N-methylpyrolidone, N, N-dimethylholmeamide, tetrahydrofuran, dimethylacetoamide, dimethyl sulfoxide, hexamethylsulfonamide, tetramethyl urea, acetone and methyl ethyl ketone and water. The solvents can be used alone or in combination. Among them, N-methylpyrolidone is preferably used. If necessary, dispersant can be added and nonion type dispersant is preferably used.

An amount of binder to be added to the electrode active material is preferably 1 to 50 parts by weight, more preferably 3 to 40 parts by weight part with respect to 100 parts by weight of the electrode active material. This amount of binder varies or depends to nature and type of battery and electrode and can be reduced when adhesion of the binder is improved.

The negative pole structure and anode structure are arranged at opposite sides of a liquid-permeable separator (a porous film made of, for example, polyethylene or polypropylene). Then, the separator is impregnated with non-aqueous electrolyte to obtain a secondary battery.

This secondary battery consisting of a laminate of negative pole structure having active layers opposite sides/separator/positive pole structure having active layers opposite sides/separator is wound up into a roll (spiral-roll) and is inserted into a bottomed metal casing After the negative pole is connected to a negative terminal while positive pole is connected to a positive terminal, an assembly is impregnated with electrolyte, and then the metal casing is sealed to obtain a cylindrical secondary battery.

The electrolyte used for lithium ion secondary battery may be lithium salt dissolved in a non-aqueous organic solvent in a concentration of about 1 M. The lithium salt may be LiPF6, LiClO4, LiBF4, LiAsF6, LiSO3CF3 and Li[(S02CF3)2N]. The non-aqueous organic solvent may be propylenecarbonate, ethylenecarbonate, 1,2-dimethoxyethane, 1,2-diethoxy ethane, dimethylcarbonate, diethylcarbonate and methylethylcarbonate which can be used alone or in combination.

### EXAMPLES

Now, the present invention will be explained with reference to Examples to which the present invention is not limited.

### SYNTHESIS OF RESINS

### Synthesis Example 1

Polyvinylidene fluoride (PVDF) latex (latex 1) was synthesized by emulsion polymerization technique described in U.S. Pat. No. 4,025,709. This latex contains 42% by weight of PVDF. A resin obtained by drying the latex has a melt index (MI) a 0.6 to 1 g/10 minutes at 230° C. under a load of 10 kg.

7.2 kg of an aqueous solution containing 15% by weight of sodium hydroxide was stored in a container of 20 liter and heated to a temperature of 70° C. Into this solution, the above-mentioned latex 1 of 7.2 kg was added under stirring at 180 rpm at a rate of 0.72 kg/min. Dehydrogenfluoride reaction proceeds immediately to produce aggregates of PVDF of dark-brown. Color of the aggregates of PVDF became darker with time during the solution was left at the same temperature under stirring.

After the above-mentioned dehydrogenfluoride reaction with sodium hydroxide was effected for 30 minutes, the resulting reaction product was kept at 70° C. and 2.5 kg of 36% of hydrochloric acid was added to adjust pH of 5. Then, 1.68 kg of 35% hydrogen peroxide was added at a rate of 0.4 kg/mine and then aqueous solution of 15% sodium hydroxide was added to adjust to pH of a range of 6.6 to 7.6.

Oxidation reaction was continued with adjusting the abovementioned pH range of the PVDF suspension by adding necessary amount of the same aqueous solution of sodium hydroxide. Aggregates of PVDF decolorized gradually with time and finally became light yellow. Oxidation treatment continued for 150 minutes. Then, aggregates was collected by filtering, washed with distilled water and dried at 105° C. to obtain fine particles (resin B1′).

The resulting resin powder was dissolved in NMP to obtain a solution of 0.1% by weight resin to which an absorbance was determined at 300 nm to find a vale of 0.19.

### Synthesis Example 2

The latex 1 was treated by the same processing as Synthesis Example 1 but the time duration of the dehydrogenfluoride reaction with aqueous solution of sodium hydroxide was changed to 90 minutes and the time duration of the oxidation reaction with hydrogen peroxide was changed to 200 minutes to obtain a resin (B2′).

The resulting resin was dissolved in NMP to obtain a solution of 0.1% by weight resin to which an absorbance was determined at 300 nm to find a vale of 0.262.

### Synthesis Example 3

The same procedure as the Synthesis Example 1 was repeated to prepare a copolymer of vinylidene fluoride and hexafluoropropylene (HFP) by emulsion polymerization technique. The resulting latex (latex 2) contains 11% of solid contents of resin whose contents of HFP is 11% by weight, having a melting point of 142° C. and a melt index (MI) under a load of 10 kg at 230° C. is 0.8 to 1 g/10 minutes.

This latex was treated by the same processing as Synthesis Example 1 but the time duration of the dehydrogenfluoride reaction with aqueous solution of sodium hydroxide was changed to 230 minutes and the time duration of the oxidation reaction with hydrogen peroxide was changed to 75 minutes to obtain a resin (B3′).

The resulting resin was dissolved in NMP to obtain a solution of 0.1% by weight resin to which an absorbance was determined at 300 nm to find a vale of 0.154.

### Synthesis Example 4

The same procedure as the Synthesis Example 1 was repeated to prepare a copolymer of vinylidene fluoride and hexafluoropropylene (HFP) by emulsion polymerization technique. The resulting latex (latex 3) contains 11% of solid contents of resin whose contents of HFP is 15% by weight, having a melting point of 132° C. and a melt index (MI) under a load of 10 kg at 230° C. is 3 to 4 g/10 minutes.

This latex was treated by the same processing as Synthesis Example 1 but the time duration of the dehydrogenfluoride reaction with aqueous solution of sodium hydroxide was changed to 250 minutes and the time duration of the oxidation reaction with hydrogen peroxide was changed to 75 minutes to obtain a resin (B4′).

The resulting resin was dissolved in NMP to obtain a solution of 0.1% by weight resin to which an absorbance was determined at 300 nm to find a vale of 0.174.

### ADHESION TEST OF RESINS

### Reference Examples 1 to 4

Each fluorine resin obtained in Synthesis Example 1 to 4 was dissolves in N-methyl pyrolidone (NMP) to obtain a solution of 10% by weight of resin. Each solution was applied on an aluminum plate and a copper plate each having a thickness of 1 mm and was left in 120° C. for 1 hour.

After the coated plates were dried under reduced pressure, films were cut into a plurality of square areas each having a side of 1 mm to effect Tessellate (cross cut) Adhesion Test (JIS K5400, 6.15). For all resins, the remaining % of the coated polymer film was 100% in the aluminum and copper plates.

Adhesion was tested also by Tape Peel Adhesion method. The result of remaining % of the coated polymer in this test also was 100% in the aluminum and copper plates. From those results, it was confirmed that adhesion of the vinylidene fluoride resin composition to the metal plates was good.

### Example 1

A homopolymer of vinylidene fluoride: “KYNAR” 761 (resin A1): a product of Elf Atochem S.A. (melt viscosity under 100 s-1 is 2700 Pa.s at 230° C.) and the fluorine type resin (B1′) obtained in Synthesis Example 1 were dissolved in N-methylpyrolidone (NMP) in such a manner that the total proportion of fluorine resin became 10% by weight and a weight ratio of (A1/B1′) became to 99/1.

The resulting solution was applied onto an aluminum plate and a copper plate each having a thickness of 1 mm and was left in 120° C. for 1 hour. After the coated plates were dried under reduced pressure, cured coated films were cut into a plurality of unit square areas each has a side of 1 mm to effect Tessellate Adhesion Test (JIS K5400, 6.15). The removal % of coated polymer film was 70% in aluminum plate and 80% in copper plate.

Adhesion was tested also by Tape Peel Adhesion method. The remaining % of the coated polymer in this test was 40% in aluminum plate and 50% in copper plate.

Comparing to Comparative Example 1, this results revealed improvement in adhesion of the vinylidene fluoride resin composition to the metal plates by a small amount of fluorine type resin (B1′) added.

### Examples 2 to 4

Procedure of Example 1 was repeated but the ratio of (A1/B1′) was changed to 95/5, 90/10 and 70/30 respectively.

The results of Tessellate Adhesion Test (JIS K5400, 6.15) and Tape Adhesion Test effected in the same way as Example 1 are summarized in Table 1.

Test results reveal that adhesion between the vinylidene fluoride resin compositions and metal plates is good.

### Example 5

Procedure of Example 1 was repeated but the resin (B2′) was used in place of (B1′) and the ratio of (A1/B2′) was changed to 90/10.

The results of Tessellate Adhesion Test (JIS K5400, 6.15) and Tape Adhesion Test effected in the same way as Example 1 are summarized in Table 1. Test result reveals that adhesion between the vinylidene fluoride resin compositions and metal plates is good.

### Example 6

Procedure of Example 5 was repeated but the resin (B3′) was used, in place of (B2′) and the ratio of (A1/B3′) was changed to 95/5.

The results of Tessellate Adhesion Test (JIS K5400, 6.15) and Tape Adhesion Test effected in the same way as Example 5 are summarized in Table 1. Test result reveals that adhesion between the vinylidene fluoride resin compositions and metal plates is good.

### Example 7

A homopolymer of vinylidene fluoride: “KYNAR” 2801 (resin A2): a product of Elf Atochem S.A. (melting point=143° C., melt viscosity under 100 s-1 is 2400 Pa.s at 230° C.) and the fluorine type resin (B1′) obtained in Synthesis Example 1 were dissolved in N-methylpyrolidone (NMP) in such a manner that the total proportion of fluorine resin became 10% by weight and a weight ratio of (A1/B1′) became to 90/10.

The resulting solution was applied onto an aluminum plate and a copper plate each having a thickness of 1 mm and was left in 120° C. for 1 hour. After the coated plates were dried under reduced pressure, cured coated films were evaluated by the same Tessellate Adhesion Test and Tape Peel Adhesion method as Example 1.

Test results are summarized in Table 1. Test result reveals that adhesion between the vinylidene fluoride resin compositions and metal plates is good.

### Example 8

Procedure of Example 7 was repeated but the resin (B3′) was used in place of (B1′).

Test results are summarized in Table 1. Test result reveals that adhesion between the vinylidene fluoride resin compositions and metal plates is good.

### APPLICATION TO BATTERY

### Example 9

100 g of coal pitch coke pulverized in a ball mill as a carrier of negative pole active material was added to and dispersed into 100 g of the NMP solution obtained in Example 4 (the total proportion of fluorine resin=10% by weight and a weight ratio of (A1/B1′)=70/30) to prepare a slurry.

This slurry was applied onto a surface of a copper foil having a thickness of 20 μm, as a current collector and dried at 130° C. for 15 minutes to obtain an electrode structure (as negative pole) having a thickness 11 μm and a width of 20 mm.

An adhesive tape was glued to a electrode active layer on a surface of the electrode structure to determine the peel adhesion between the current collector and the electrode active layer by a tensile tester to find a peel strength of 80 g/cm. Still more, considerable amount of electrode active material remained on a surface of the current collector. These facts showed that adhesive between the electrode active material and the current collector was very strong.

In another adhesion test, the electrode structure was wound around a cylinder having a diameter 1 mm and the peel adhesion was measured to find no peel of the electrode active layer. Then, the electrode structure was immersed in ethylenecarbonate and left for 3 days at 60° C. but no peel of the electrode active layer was observed.

### Example 10

91 g of LiCoO2 (as a positive electrode active material), 3 g of acetylene black (as a conductor) and 60 g of the NMP solution containing 10% by weight of resin obtained in Example 3 (as a binder) were mixed to prepare a slurry paste). This slurry was applied to a surface of aluminum foil having a thickness of 20 μm (as a current collector) and dried at 130° C. for 15 minutes to produce an electrode structure (used as a positive electrode) having a thickness 100 μm and a width of 20 mm.

Peel adhesion between the current collector and the electrode active layer was 140 g/cm. Good adhesion was confirmed in other test described in Example 9.

### Comparative Example 1

10 g of polyvinylidene fluoride (KYNAR 7619) was dissolved in 90 g of NMP to obtain a solution. This solution was then applied onto aluminum plate and copper plate each having a thickness of 1 mm and heated at 120° C. for 1 hour. After the resulting coated films were dried under reduced pressure, the peel adhesion was determined by the same Tessellate Adhesion Test as Example 1 to find a remaining % of less than 20% for both of aluminum and copper plates. In the Tape Peel Adhesion test, the coated films peeled off totally.

### Comparative Example 2

Procedure of Comparative Example 1 was repeated but KYNAR 2801 which is a copolymer of vinylidenefluoride and hexafluoropropylene (HFP): a product of Elf Atochem S.A. was used in place of (KYNAR 761).

Peel adhesion was determined by the same Tessellate Adhesion Test and by Tape Peel Adhesion test as Comparative Example 1. Test results are summarized in Table. Good adhesion was not observed.

TABLE 1

| | | | | Tessellate peel | | Tape peel | |
|---|---|---|---|---|---|---|---|
| | | | A/B′ | adhesion test | | adhesion test | |
| | Resin A | Resin B′ | (by weight) | aluminium plate | copper plate | aluminium plate | cooper plate |
| Example 1 | KYNAR 761 | B₁′ | 99/1 | 70 | 80 | 40 | 50 |
| Example 2 | KYNAR 761 | B₁′ | 95/5 | 90 | 100 | 80 | 95 |
| Example 3 | KYNAR 761 | B₁′ | 90/10 | 100 | 100 | 95 | 100 |
| Example 4 | KYNAR 761 | B₁′ | 70/30 | 100 | 100 | 100 | 100 |
| Example 5 | KYNAR 761 | B₂′ | 90/10 | 100 | 100 | 100 | 100 |
| Example 6 | KYNAR 761 | B₃′ | 95/5 | 95 | 100 | 90 | 96 |
| Example 7 | KYNAR 2801 | B₁′ | 90/10 | 100 | 100 | 100 | 100 |
| Example 8 | KYNAR 2801 | B₃′ | 90/10 | 100 | 100 | 100 | 100 |
| Reference | none | B₁′ | 0/100 | 100 | 100 | 100 | 100 |
| Example 1 | | | | | | | |
| Reference | none | B₂′ | 0/100 | 100 | 100 | 100 | 100 |
| Example 2 | | | | | | | |
| Reference | none | B₃′ | 0/100 | 100 | 100 | 100 | 100 |
| Example 3 | | | | | | | |
| Reference | none | B₄′ | 0/100 | 100 | 100 | 100 | 100 |
| Example 4 | | | | | | | |
| Comparative | KYNAR 761 | none | 100/0 | <20 | <20 | 0 | 0 |
| Example 1 | | | | | | | |
| Comparative | KYNAR 2801 | none | 100/0 | 20 | 30 | 0 | 10 |
| Example 2 | | | | | | | |

### Comparative Example 3

Procedure of Example 9 was repeated but the NMP solution of KYNAR 761 obtained in Comparative Example 1 was used to produce a negative pole structure in the same manner as Example 9.

Peel adhesion between the current collector and the negative electrode active was so low as 15 g/cm. Peel off of an electrode active layer of this electrode was observed when the electrode was wound around a cylinder having a diameter of 1 mm. Considerable amount of the electrode active layer peeled off when the electrode was immersed in ethylenecarbonate heated at 60° C.

### Comparative Example 4

Procedure of Example 10 was repeated but the NMP solution of KYNAR 761 obtained in Comparative Example 1 was used to produce a positive pole structure in the same manner as Example 10.

Peel adhesion between the current collector and the positive electrode active was 40 g/cm which is lower than the value of Example 10. Peel off of an electrode active layer of this electrode was observed when the electrode was wound around a cylinder having a diameter of 1 mm. Considerable amount of the electrode active layer peeled off when the electrode was immersed in ethylenecarbonate heated at 60° C.

### ADVANTAGES OF THE INVENTION

The present invention provides a fluorine type adhesive resin composition improved in adhesion without spoiling solvent-resistance and mechanical/thermal properties which fluorine type resin inherently possess and which can be prepared easily. The fluorine type adhesive resin composition is advantageously applicable in a binder for an electrode structure for battery improved in adhesion between the electrode active material and the current, so that separation of electrode active material from the current collector in battery manufacturing stage and the discharge capacitance of the resulting secondary battery does not degrade in repeated charge-discharge operations. The fluorine type adhesive resin composition according to the present invention is especially useful in non-water type secondary battery.

1 Fluorine type adhesive resin composition consists of (A) at least one fluorine type resin and (B′) at least one chemically denatured fluorine type resin obtained by partial dehydrogenfluoride reaction and oxidation reaction, a weight ratio of A/B′ being 30/70 to 99/1.

2 The fluorine type adhesive resin composition set forth in claim 1, wherein said fluorine type resin (A) is homopolymer of vinylidene fluoride.

3 The fluorine type adhesive resin composition set forth in claim 1, wherein said fluorine type resin (A) is a copolymer of vinylidene fluoride and at least one monomer selected from a group consisting of tetrafluoroethylene, hexafluopropylene, trifluoroethylene and trifluorochloroethylene, a proportion of the vinylidene fluoride in the said copolymer being 50 to 98% by weight.

4 The fluorine type adhesive resin composition set forth in claim 1, wherein said fluorine type resin (A) is a mixture of 1 to 99% by weight of the homopolymer of vinylidene fluoride and 99 to 1% by weight of said copolymer of vinylidene fluoride set forth in claim 3.

5 The fluorine type adhesive resin composition set forth in any one of claims 1 to 4, wherein said chemically denatured fluorine type resin (B′) is a resin obtained by partial dehydrogenfluoride and oxidation reactions of the homopolymer of vinylidene fluoride.

6 The fluorine type adhesive resin composition set forth in any one of claims 1 to 4, wherein said chemically denatured fluorine type resin (B′) is a resin obtained by partial dehydrogenfluoride and oxidation reactions of the copolymer of vinylidene fluoride and at least one monomer selected from a group consisting of tetrafluoroethylene, hexafluopropylene, trifluoroethylene and trifluorochloroethylene, a proportion of the vinylidene fluoride in the said copolymer being 50 to 98% by weight.

7 A solution of at least one fluorine type resin (A) and at least one chemically denatured fluorine type resin (B′) dissolved in organic solvent, a weight ratio of (A/B′) being 30/70 to 99/1 and the total amount of A+B′ being 0.1 to 50% by weight in said solution.

8 Dispersion or emulsion obtained by dispersing or emulsifying at least one fluorine type resin (A) and at least one chemically denatured fluorine type resin (B′) obtained by partial dehydrogenfluoride reaction and oxidation reaction, a weight ratio of ANB′ being 30/70 to 99/1, the total amount of A +B′being 1 to 70% by weight in said Dispersion or emulsion.

9 An electrode for battery having a current collector on a surface of which a layer of electrode-constructing material comprising at least one electrode active material and a binder is deposited, characterized in that said binder is the fluorine type adhesive resin composition set forth in any one of claims 1 to 6.
